(19) United States
(12) Patent Application Publication
(10) Pub. No.: US 2010/0090500 A1
(43) Pub. Date: Apr. 15, 2010

(54) Elements of the body of a Vehicle

(75) Inventors: Giampaolo Montineri, Perugia (IT); Ottorino Ori, Torrile (IT)

Correspondence Address: CNH AMERICA LLC, INTELLECTUAL PROPERTY LAW DEPARTMENT, PO BOX 1895, M.S. 641, NEW HOLLAND, PA, 17557, US

(73) Assignee: CNH AMERICA LLC, New Holland, PA (US)

(21) Appl. No.: 12/250,430

(22) Filed: Oct. 13, 2008

(51) Int. Cl. B62D 25/00

(52) U.S. Cl. 296/191

(57) ABSTRACT

An element of a body of a vehicle has a substrate portion formed by a first material and an outer portion formed by a second material suitable to be coupled with each other. At least the outer portion is provided with coupling elements for releasably coupling the outer portion and the substrate portion with each other. The coupling elements are dimensioned to allow different expansion of the materials used for the substrate portion and the outer portion.

The present invention concerns elements of the body of a vehicle, in particular elements having an aesthetical function, such as side panels, roof panels, fenders, hoods, hatchbacks, etc.

From the state of art body elements are known comprising a thermoformed outer portion having aesthetical functions obtained from panels of abs/pmma resins and a substrate portion on which the outer portion is fixed by gluing or fastening with screws or rivets. As an alternative a substrate of polyurethane foam with glass fiber may be coupled to the thermoformed outer portion.

The above mentioned body elements have the drawback that, if it is required to replace the outer portion of the element, such as in the event of damage, it is necessary to replace the whole element. It is not possible to separate the outer portion from the substrate without damaging the substrate. Additionally it is not possible to easily change the color of the body panels.

### SUMMARY OF THE INVENTION

An element of the body of a vehicle has a substrate portion and an outer portion coupled with each other, so that at least said outer portion is provided with coupling elements for releasably coupling said outer portion and said substrate portion with each other.

If it is required to replace the outer portion of a body element, it is not necessary to replace the whole element, because it is possible to separate easily the outer portion from the substrate portion without damaging the substrate portion.

### BRIEF DESCRIPTION OF THE DRAWINGS

Further features and advantages of the invention will be disclosed here below with reference to the enclosed drawings, illustrating some embodiments of the invention by way of non-limiting example, in which:

FIG. 1 is a perspective view of a first embodiment of an element of a vehicle body according to the invention, in a non-assembled condition;

FIG. 2 is a perspective view of the element of FIG. 1, in an assembled condition;

FIG. 3 is a perspective view of a second embodiment of an element of a vehicle body according to the invention, in a non-assembled condition;

FIG. 4 is a perspective view of the outer portion of the element of FIG. 3;

FIG. 5 is a top perspective view of the element of FIG. 3, in an assembled condition;

FIG. 6 is a bottom perspective view of the element of FIG. 3, in an assembled condition;

FIG. 7 is a perspective view of a third embodiment of an element of a vehicle body according to the invention, in a non-assembled condition;

FIG. 8 is a perspective view of the outer portion of the element of FIG. 7;

FIG. 9 is a top perspective view of the element of FIG. 7, in an assembled condition;

FIG. 10 is a bottom perspective view of the element of FIG. 7, in an assembled condition;

FIG. 11 is a perspective view of a fourth embodiment of an element of a vehicle body according to the invention, in a non-assembled condition;

FIG. 12 is a perspective view of the outer portion of the element of FIG. 11;

FIG. 13 is a top perspective of the element of FIG. 11, in an assembled condition;

FIG. 14 is a bottom perspective view of the element of FIG. 11, in an assembled condition;

FIG. 15 is a perspective view of a fifth embodiment of an element of a vehicle body according to the invention, in a non-assembled condition;

FIG. 16 is a perspective view of the outer portion of the element of FIG. 15;

FIG. 17 is a top perspective view of the element of FIG. 15, in an assembled condition;

FIG. 18 is a bottom perspective view of the element of FIG. 15, in an assembled condition.

### DETAILED DESCRIPTION OF THE INVENTION

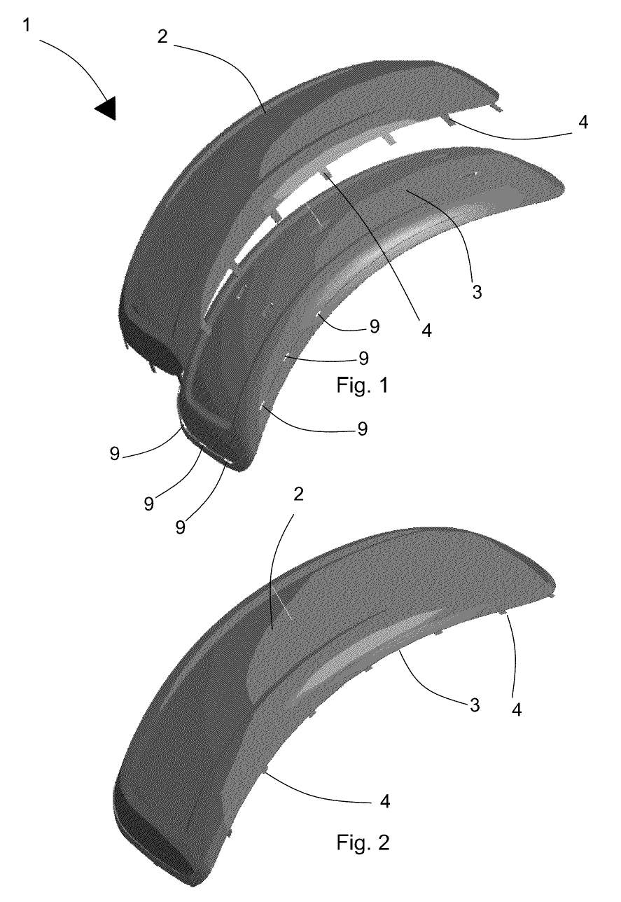

FIGS. 1 and 2 illustrate a first embodiment of an element 1 of a vehicle body, for instance a fender. The element 1 comprises an outer portion 2 having primarily an aesthetic function and a substrate 3 designed to give mechanical strength to the element 1. As an example, the outer portion may be made, of a thermoformed panel of abs/pmma resins and the substrate 3 may be made, of a plastic material. However any other suitable material may be used for the outer portion 2 and the substrate portion 3.

The outer portion 2 is provided with coupling elements 4 in the form of a plurality of appendages, which could be shaped tabs, distributed along an edge of the outer portion 2.

Coupling between the outer portion 2 and the substrate 3 is obtained by bending the coupling elements 4 against a surface of the substrate 3 so as to lock the substrate 3 to the outer portion 2.

If necessary, the coupling elements 4 may be heated before being bent, particularly if the outer portion 2 and the coupling elements 4 are made of a thermoformable material.

If the outer portion 2 is to be replaced, for any reason, the coupling elements 4 may be straightened, or broken, to separate the outer portion 2 from the substrate 3 so that a new outer portion 2 may be coupled with the substrate 3.

To improve the coupling between the outer portion 2 and the substrate 3, the substrate 3 may be provided with slits 9 into which the coupling elements may be inserted before being bent against a surface of the substrate 3.

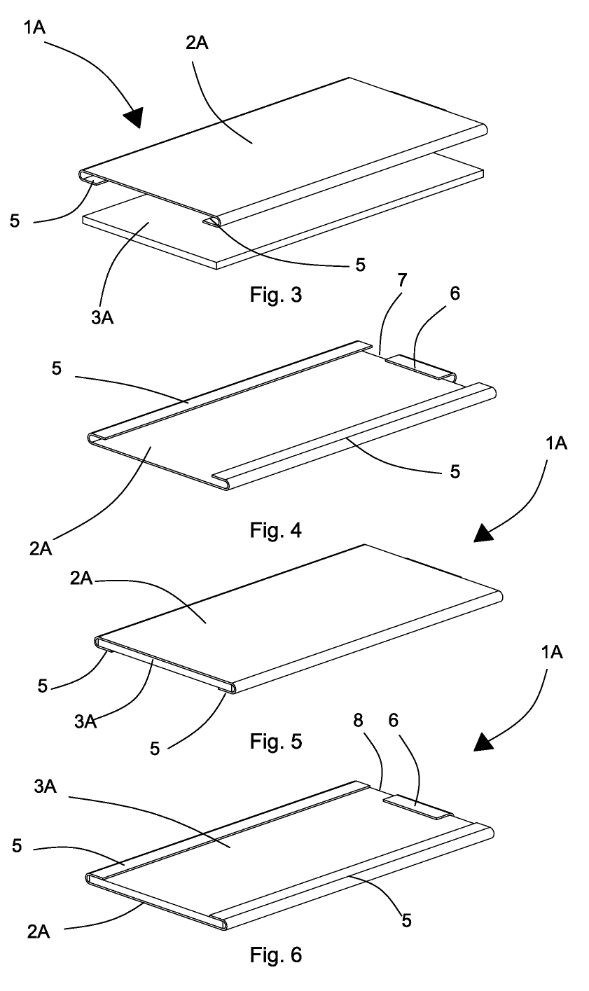

FIGS. 3-6 illustrate a second embodiment of an element 1A of a vehicle body. The element 1A comprises an outer portion 2A and a substrate 3A having substantially a flat rectangular shape. The outer portion 2A is provided with opposed shaped edges 5 having a “C”-shaped cross section and constituting a first coupling element for coupling the outer portion 2A with the substrate 3A. The opposed edges 5 act as guides and positioning elements when the substrate 3A is coupled with the outer portion 2A.

A third edge 7 of the outer portion 2A is provided with a shaped appendage 6 having a “C”-shaped cross section, said appendage 6 acting as a second coupling element.

The substrate 3A is so dimensioned as to be insertable into the “C”-shaped cross section of the opposed edges 5 of the outer portion 2A.

Coupling of the substrate 3A with the outer portion 2A is obtained by inserting the substrate 3A into the opposed edges 5 of the outer portion 2A and sliding the substrate 3A along said opposed edges 5 until an edge 8 of the substrate 3A inserts into the “C”-shaped cross section of the appendage 6. The appendage 6 is so dimensioned as to obtain an interference fit between the edge 8 of the substrate 3A and the appendage 6 in order to lock the substrate 3A with the outer portion 2A.

If the outer portion 2A is to be substituted, it is sufficient to elastically deform the appendage 6 until the edge 8 of the substrate 3A may be disengaged from the appendage 6 and separated by the outer portion 2A by being slid along the opposed edges 5 of the outer portion 2A.

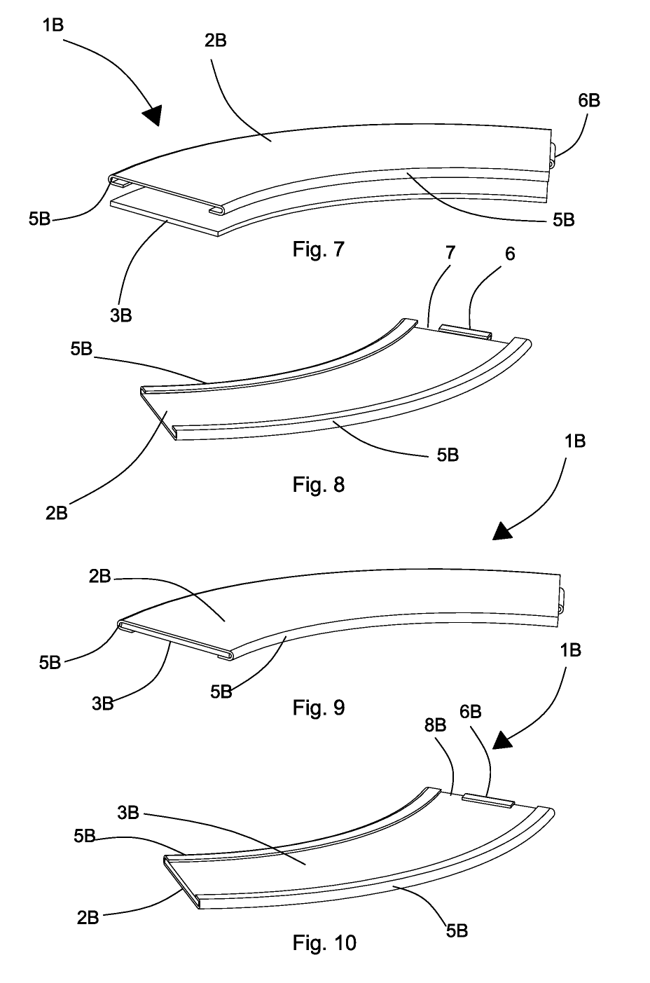

FIGS. 7 to 10 illustrate a third embodiment of an element 1B of a vehicle body. The element 1B comprises an outer portion 2B and a substrate 3B having a substantially flat curvilinear shape. The outer portion 2B is provided with shaped opposed edges 5B having a “C”-shaped cross section and constituting a first coupling element for coupling the outer portion 2B with the substrate 3B. The opposed edges 5B act as guides and positioning elements when the substrate 3B is coupled with the outer portion 2B.

A third edge 7B of the outer portion 2B is provided with a shaped appendage 6B having a “C”-shaped cross section, said appendage 6B acting as a second coupling element.

The substrate 3B is so dimensioned as to be insertable into the “C”-shaped cross section of the opposed edges 5B of the outer portion 2B.

Coupling of the substrate 3B with the outer portion 2B is obtained by inserting the substrate 3B into the opposed edges 5B of the outer portion 2B and sliding the substrate 3B along said opposed edges 5B until an edge 8B of the substrate 3B inserts into the “C”-shaped section of the appendage 6B.

The appendage 6B is dimensioned to obtain an interference fit between the edge 8B of the substrate 3B and the appendage 6B in order to lock the substrate 3B with the outer portion 2B.

If the outer portion 2B is to be substituted, it is sufficient to deform elastically the appendage 6B until the edge 8B of the substrate 3B may be disengaged from the appendage 6B and separated by the outer portion 2B by being slid along the opposed edges 5B of the outer portion 2B.

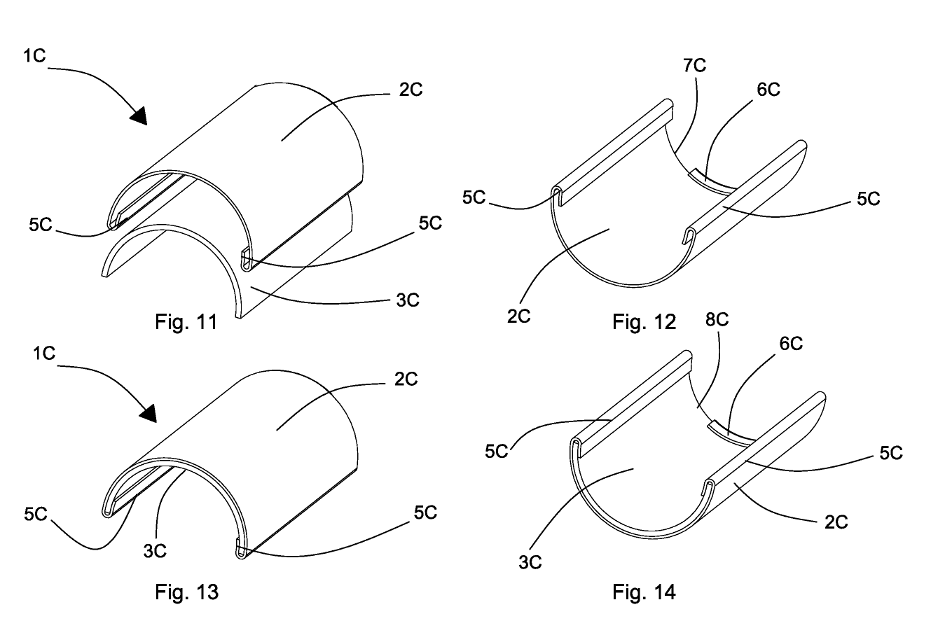

FIGS. 11 to 14 illustrate a fourth embodiment of an element 1C of a vehicle body. The element 1C comprises an outer portion 2C and a substrate 3C having a shape with resembles a cradle with a “U” shaped cross section. The outer element 2C is provided with shaped opposed edges 5C having a “C”-shaped cross section and constituting a first coupling element for coupling the outer portion 2C with the substrate 3C. The edges 5C act as guides and positioning elements when the substrate 3C is coupled with the outer portion 2C.

A third edge 7C of the outer portion 2C is provided with a shaped appendage 6C having a “C”-shaped cross section, said appendage 6C acting as a second coupling element.

The substrate 3C is so dimensioned as to be insertable into the “C”-shaped cross section of the opposed edges 5C of the outer portion 2C.

Coupling of the substrate 3C with the outer portion 2C is obtained by inserting the substrate 3C into the opposed edges 5C and sliding the substrate 3C along said edges 5C until an edge 8C of the substrate 3C inserts into the “C”-shaped section of the appendage 6C. The appendage 6C is dimensioned to obtain an interference fit between the edge 8C of the substrate 3C and the appendage 6C in order to lock the substrate 3C with the outer portion 2C.

If the outer portion 2C is to be substituted, it is sufficient to deform elastically the appendage 6C until the edge 8C of the substrate 3C may be disengaged from the appendage 6C and separated by the outer portion 2C by being slid along the opposed edges 5C of the outer portion 2C.

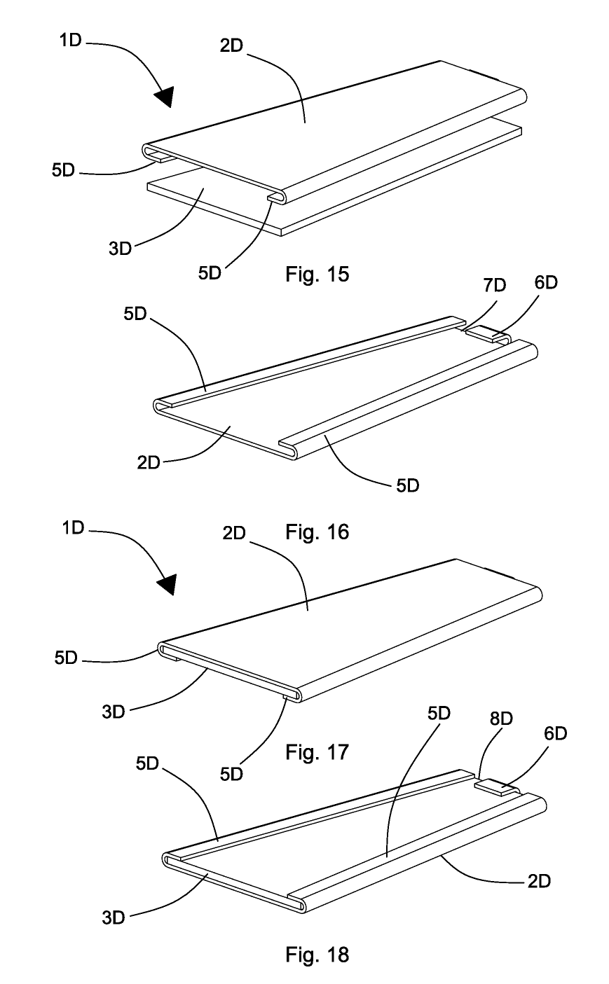

FIGS. 15 to 18 illustrate a fifth embodiment of an element 1D of a vehicle body. The element 1D comprises an outer portion 2D and a substrate 3D having a substantially flat trapezoidal shape. The element 1D is provided with shaped opposed edges 5D having a “C”-shaped cross section and constituting a first coupling element for coupling the substrate 3D with the outer portion 2D. The opposed edges 5D act as guides and positioning elements when the substrate 3D is coupled with the outer portion 2D.

A third edge 7D of the outer portion 2D is provided with a shaped appendage 6D having a “C”-shaped cross section, said appendage 6D acting as a second coupling element.

The substrate 3D is dimensioned as to be insertable into the “C”-shaped cross section of the opposed edges 5D of the outer portion 2D.

Coupling of the substrate 3D with the outer portion 2D is obtained by inserting the substrate 3D into the opposed edges 5D and sliding the substrate 3D along said edges 5D until an edge 8D of the substrate 3D inserts into the “C”-shaped section of the appendage 6D. The appendage 6D is so dimensioned as to obtain an interference fit between the edge 8D of the substrate 3D and the appendage 6D in order to lock the substrate 3D with the outer portion 2D.

If the outer portion 2D is to be substituted, it is sufficient to deform elastically the appendage 6D until the edge 8D of the substrate 3D may be disengaged from the appendage 6D and separated by the outer portion 2D by being slid along the opposed edges 5D of the outer portion 2D.

In all embodiments, sufficient clearance needs to be maintained between the substrate 3 and the outer portion 2 to allow relative movement between each other due to e.g. different expansion capacity of both materials due to an external heating source, e.g. sunlight, which can heat up the different materials.

This is obtained in the first embodiment by making the slits 9 large enough or in a specific shape to allow movement of the coupling elements in the directions of expansion.

In the second, third, forth and fifth embodiments, this is accomplished by providing sufficient clearance between the outer portion and the substrate.

In the case that the material of the substrate expands more than the material of the outer portion, the edges 5, 5B, 5C, 5D and the appendage 6, 6B, 6C, 6D of the outer portion are sufficient large to allow the substrate to expand when e.g. heated, but to prevent the substrate from falling out of the outer portion when the materials are expanding.

If the material of the outer portion expands more than the material of the substrate, sufficient space is foreseen between the substrate and the outer portion, to allow insertion of the substrate into the outer portion. Also, the edges and the appendage of the embodiments need to be sufficiently large to prevent the substrate from falling out of the outer portion when both materials and one of the materials expands, such as due to an external heating source.

The available space between the substrate and the outer portion together with the dimensions of the slits, edges and the appendages of the embodiments needs to be chosen based on the materials used and how they individually respond to influences from the environment.

The illustrated embodiments of the invention are only examples of possible embodiments of the invention. Many other shapes of the outer portion and the substrate portion may be conceived. Similar techniques could be applied to grills, air intakes or holes in the external surface and in the internal substrate of a vehicle.

1. An element of a body of a vehicle comprising
a substrate portion formed by a first material and an outer portion formed by a second material;
wherein at least said outer portion is provided with coupling elements for releasably coupling said outer portion and said substrate portion with each other, the coupling elements configured to allow different expansion of the materials used for the substrate portion and the outer portion.

2. The element according to claim 1, wherein said substrate portion is provided with further coupling elements designed to interact with said coupling elements of the outer portion.

3. The element according to claim 2, wherein said further coupling elements comprising a plurality of slits configured to be coupled with said coupling elements.

4. The element according to claim 1, wherein said coupling elements comprise a plurality of appendages of said outer portion.

5. The element according to claim 4, wherein said appendages are shaped as tabs.

6. The element according to claims 1, wherein said coupling elements comprise two shaped opposite edges of said outer portion.

7. The element according to claim 6, wherein said shaped opposite edges have a substantially “C”-shaped cross section.

8. The element according to claim 6, wherein said coupling elements comprise a shaped appendage of a further edge of said outer portion, said appendage being so shaped and dimensioned as to couple with interference fit with an edge of said substrate portion.

9. The element according to claim 8, wherein said shaped appendage has a substantially “C”-shaped cross section.

10. The element according to claim 1, wherein said outer portion has a substantially flat rectangular shape.

11. The element according to claim 10, wherein said substrate portion has a substantially flat rectangular shape.

12. The element according to claim 1, wherein said outer portion has a substantially flat curvilinear shape.

13. The element according to claim 12, wherein said substrate portion has a substantially flat curvilinear shape.

14. The element according to claim 1, wherein said outer portion is shaped substantially as a cradle with a substantially “U”-shaped cross section.

15. The element according to claim 14, wherein said substrate portion is shaped substantially as a cradle with a substantially “U”-shaped cross section.

16. The element according to claim 1, wherein said outer portion has a substantially flat trapezoidal shape.

17. The element according to claim 16, wherein said substrate portion has a substantially flat trapezoidal shape.

18. The element according to claim 1, wherein the shape of said outer portion and the shape of said substrate portion are similar to each other, to allow a releasable coupling between said outer portion and said substrate portion.
